(19) United States
(12) Patent Application Publication
(10) Pub. No.: US 2012/0008856 A1
(43) Pub. Date: Jan. 12, 2012

(54) Automatic Convergence Based on Face Detection for Stereoscopic Imaging

(76) Inventors: Gregory Robert Hewes, Sachse, TX (US); Fred William Ware, JR., Carrollton, TX (US); Wei Hong, Sunnyvale, CA (US); Mark Noel Gamadia, Longmont, CO (US)

(21) Appl. No.: 13/177,525

(22) Filed: Jul. 6, 2011

Related U.S. Application Data
(60) Provisional application No. 61/362,475, filed on Jul. 8, 2010.

(51) Int. Cl. G06K 9/00

(52) U.S. Cl. 382/154

(57) ABSTRACT

A method for automatic convergence of stereoscopic images is provided that includes receiving a stereoscopic image, selecting a face detected in the stereoscopic image, and shifting at least one of a left image in the stereoscopic image and a right image in the stereoscopic image horizontally, wherein horizontal disparity between the selected face in the left image and the selected face in the right image before the shifting is reduced. In some embodiments, the horizontal disparity is reduced to zero

### CROSS-REFERENCE TO RELATED APPLICATIONS

This application claims benefit of U.S. Provisional Patent Application Ser. No. 61/362,475, filed Jul. 8, 2010, which is incorporated by reference herein in its entirety. This application is related to the co-pending and commonly assigned U.S. patent application Ser. No. ______, filed Jul. ______, 2011 (TI-69383).

### BACKGROUND OF THE INVENTION

1. Field of the Invention

Embodiments of the present invention generally relate to a method and apparatus for automatically converging stereoscopic images based on face detection.

2. Description of the Related Art

In human visual systems or stereoscopic camera systems, the point of intersection of the two eye axes or two camera axes is the convergence point. The distance from the convergence point to the eye or camera is the convergence distance. For human eyes, the convergence point can be at arbitrary distance. For stereoscopic cameras, the convergence point may be, for example, at infinity (for a parallel camera configuration) or at a fixed distance (for a toe-in camera configuration).

When a person looks at a stereoscopic image or video on a stereoscopic display, the eyes naturally converge to the display screen. The distance from the display screen to the eyes is the natural convergence distance. However, to view the 3D effect correctly, the viewer's eyes adjust to have the same convergence distance as the camera. Such constant convergence distance adjustment can cause discomfort over time such as headaches or eye muscle pain.

### SUMMARY

Embodiments of the present invention relate to a method, apparatus, and computer readable medium for automatic convergence of stereoscopic images. The method includes receiving a stereoscopic image, selecting a face detected in the stereoscopic image, and shifting at least one of a left image in the stereoscopic image and a right image in the stereoscopic image horizontally, wherein horizontal disparity between the selected face in the left image and the selected face in the right image before the shifting is reduced. In some embodiments, the horizontal disparity is reduced to zero.

### BRIEF DESCRIPTION OF THE DRAWINGS

Particular embodiments in accordance with the invention will now be described, by way of example only, and with reference to the accompanying drawings:

FIG. 1 shows a block diagram of a stereoscopic imaging system in accordance with one or more embodiments;

FIG. 2 shows a flow diagram of a method for automatic convergence of stereoscopic images in accordance with one or more embodiments;

FIGS. 3A and 3B show an example in accordance with one or more embodiments; and

FIG. 4 shows a block diagram of an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

A stereoscopic image is a three dimensional (3D) representation of a scene. Further, a stereoscopic image may include two two dimensional (2D) images, a left image and a right image, that are obtained, for example, by imaging sensors positioned at slightly different viewpoints such that the same objects appear in each image but are shifted horizontally in one image relative to the other. Further, objects at different depths in the scene will have different displacements in the left and right images, thus creating a sense of depth when the stereoscopic image is viewed on a stereoscopic display. The left and right 2D images may be corresponding frames of two video sequences or corresponding single still 2D images. Thus, a stereoscopic image may be two corresponding frames of two video sequences or two corresponding still 2D images.

The term disparity refers to the shift that occurs at each point in a scene between the left and right images. This shift may be mostly horizontal when the imaging sensors used to capture the left and right images are offset horizontally. Further, the amount of shift or disparity may vary from pixel to pixel depending on the depth of the corresponding 3D point in the scene. At the point of convergence, corresponding objects in the left and right images are said to have zero horizontal disparity and, when viewed on a stereoscopic display, will appear to be on the display plane. Objects in front of the convergence point will have negative disparity, i.e., an object in the left image is horizontally shifted to the right of the corresponding object in the right image and will appear in front of the display plane. Objects behind the convergence point will have positive disparity, i.e., an object in the left image is horizontally shifted to the left of the corresponding object in the right image and will appear to be behind the display plane.

To improve viewing comfort, the convergence distance of a stereoscopic image can be adjusted so that the convergence distance approximates the natural convergence distance of human eyes. Such adjustment of the convergence distance may be accomplished by horizontally shifting the left image and/or the right image of the stereoscopic image, i.e., by changing the horizontal disparity between the left and right images.

Embodiments of the invention provide for automatic convergence of stereoscopic images based on face detection. More specifically, the convergence distance of a stereoscopic image is automatically reduced based on a face detected in the scene in the stereoscopic image. That is, a face detected in a stereoscopic image is selected, and the left image and/or the right image of the stereoscopic image is then shifted such that the horizontal disparity between the selected face in the left image and the selected face in the right image is reduced. In some embodiments, the horizontal disparity is reduced to zero after the left image and/or right image is shifted. The amount(s) of horizontal shifting and the direction(s) of the shifting are determined based on the horizontal disparity between the face in the left image and the face in the right image.

In some embodiments, when multiple faces are detected in a stereoscopic image, various criteria are applied to select an appropriate face for convergence from the multiple faces. The criteria may be based on one or more of the relative sizes, locations, and convergence metrics of the detected faces, and disparity limit(s). Disparity limit(s) are explained in more detail herein.

The horizontal disparity between a face in a left image of a stereoscopic image and a face in the right image may be determined as the difference between the X coordinate of a pixel in the left face and the X coordinate of the corresponding pixel in the right face. In some embodiments, the horizontal disparity is calculated as X_{R}−X_{L} and in other embodiments the horizontal disparity is calculated as X_{L}−X_{R}, where X_{R} is the X coordinate of a pixel in the right face and X_{L} is the X coordinate of the corresponding pixel in the left face. In some embodiments, the pixels used for the horizontal disparity calculation are the center pixels of the left and right faces.

The descriptions of the illustrative embodiments and examples herein assume that the horizontal disparity between left and right faces is calculated as X_{R}−X_{L} and that both the left and the right images are shifted. Further, the descriptions assume that horizontal disparity between the left and right faces is to be reduced to zero. One of ordinary skill in the art, having benefit of this disclosure, will understand other embodiments in which the horizontal disparity is calculated as X_{L}−X_{R} and/or in which only the left image or the right image is shifted and/or which the amount the horizontal disparity is reduced is greater than zero without need for additional explanation.

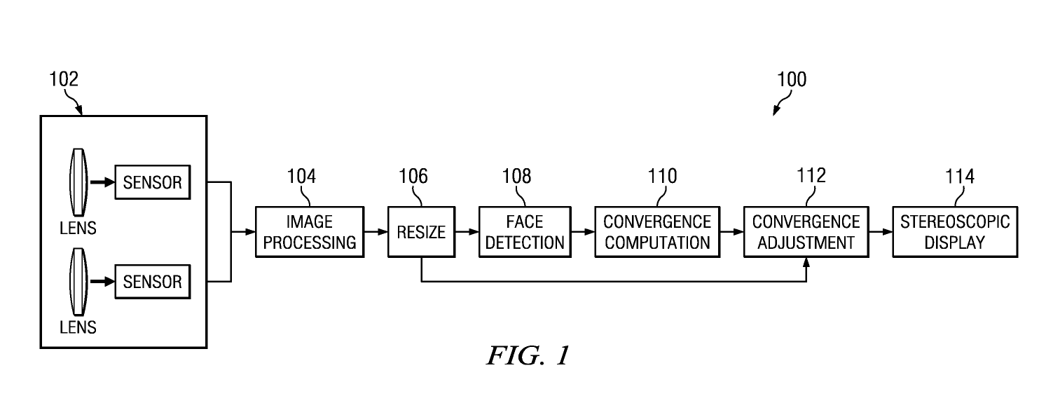

FIG. 1 shows a block diagram of stereoscopic imaging system 100 in accordance with one or more embodiments. The stereoscopic imaging system 100 includes a stereo imaging component 102, an image processing component 104, a resize component 106, a face detection component 108, a convergence computation component 110, a convergence adjustment component 112, and a stereoscopic display 114.

The stereo imaging component 102 includes two lens configurations, two apertures, and two imaging sensors arranged to capture image signals of a scene from a left viewpoint and a right viewpoint. That is, one lens configuration, aperture, and imaging sensor is arranged to capture an image signal from the left viewpoint, i.e., a left analog image signal, and the other lens configuration, aperture, and imaging sensor is arranged to capture an image signal from the right view point, i.e., a right analog image signal. A lens configuration and aperture may be any suitable lens configuration and aperture. For example, a lens configuration may include a zoom lens and a focus lens. An imaging sensor may be any suitable imaging sensor such as, for example, a CMOS (Complementary Metal-Oxide Semiconductor) or CCD (Charge Coupled Device) image sensor. The stereo imaging component 102 also includes circuitry for controlling various aspects of the operation of the component, such as, for example, lens position, aperture opening amount, exposure time, etc. The stereo imaging component 102 further includes functionality to convert the left and right analog image signals to left and right digital image signals and to provide the left and right digital image signals to the image processing component 104.

The image processing component 104 divides the left and right digital signals into left and right digital images, and processes each digital image to enhance the scene in the digital image. The image processing performed may include one or more image enhancement techniques such as, for example, black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment.

The resize component 106 resizes the left and right digital images from the image processing component 104 as needed to meet the input requirements of other components. For example, the resize component 106 may resize the left and right digital images to QVGA (320×240) for processing by the face detection component 108. Such resized images are referred to as detection images herein. The resize component 106 may also resize the left and right digital images to include equal-sized margins on at least the left and right sides of both images to facilitate horizontal shifting of the images by the convergence adjustment component 112. Such resized images are referred to as margin images herein.

The face detection component 108 processes the left and right detection images to detect one or more faces, if any, in the left and right detection images. The face detection component 108 further generates information regarding each detected face that includes at least the size, the location, and a confidence metric for the face in each of the left detection image and the right detection image. The location of a detected face is specified as the x and y coordinates of the center of the face. The confidence metric is an indication of how much confidence the face detection component 108 has that the detected face is actually a face. The face detection component 108 may implement any suitable 3D face detection technique. The face detection component 108 may be configurable to allow for specification of a minimum face size and/or a face detection region. The minimum face size specifies the smallest face size that should be detected, and the face detection region specifies the bounds of a region in an image that is to be analyzed for detecting faces.

The convergence computation component 110 selects a suitable face, if any, detected by the face detection component 108 for convergence, and determines how much and in which direction each of the left and right images of a stereoscopic image should be shifted horizontally to converge on a selected face. The shift amounts and shift directions are determined such that the face in the final stereoscopic image will be converged, i.e., there will be zero horizontal disparity between the face in the left image and the face in the right image after shifting. As will be understood by one of ordinary skill in the art, if a horizontal disparity greater than zero is desired, the shift amounts determined to achieve zero horizontal disparity may be appropriately adjusted to achieve the desired horizontal disparity.

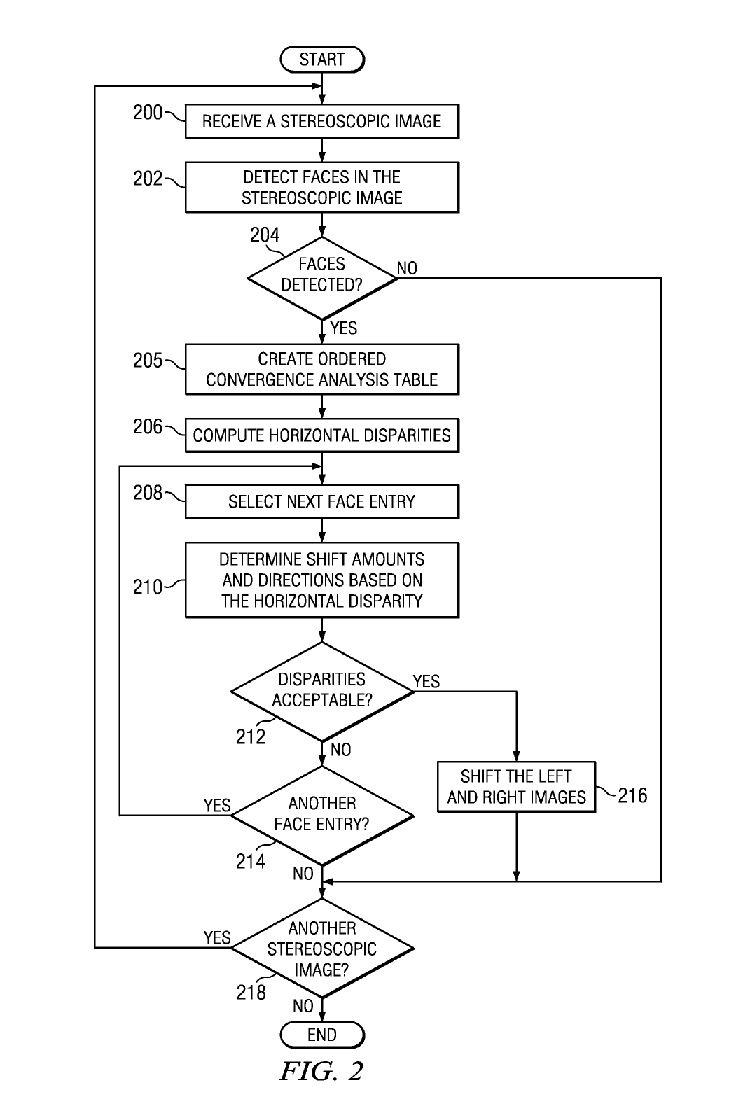

More specifically, the convergence computation component 110 uses the sizes, locations, and confidence metrics provided by the face detection component 108 regarding the detected faces, and one or more disparity limits, to select a suitable face for convergence, if any. Various techniques for selecting a suitable face that may be used in embodiments of the convergence computation component 110 are described in more detail below in reference to FIG. 2 and an example. If a suitable face is found, the convergence computation component 110 determines the shift amounts and shift directions for the left and right margin images from the horizontal disparity between the face in the right detection image and the face in the left detection image. The horizontal disparity is calculated as D=X_{R}−X_{L}, where X_{R} is the X coordinate of the center of the face in the right detection image and X_{L} is the X coordinate of the center of the face in the left detection image.

To determine the shift amounts, the horizontal disparity D is divided by 2. If D is an even integer, the shift amount for each image is |D|/2. If D is an odd integer, the shift amount for one image is rnd(|D|/2) and for the other image is rnd(|D|/2)−1. For example, if D=17, then D/2=8.5. The shift amount for one image may be 8 and for the other image may be 9. Since the images to be shifted, i.e., the margin images, are larger than the detection images, these shift amounts are then linearly translated to the appropriate shift amounts for the larger margin images. The shift directions are based on the sign of the horizontal disparity D. If D is negative, the shift direction for the left image is left and the shift direction for the right image is right. If D is positive, the shift direction for the left image is right and the shift direction for the right image is left.

The convergence adjustment component 112 generates a final stereoscopic image by shifting a left margin image horizontally according to a left image shift amount and a left image shift direction determined by the convergence computation component 110, shifting a right margin image horizontally according to a right image shift amount and a right image shift direction determined by the convergence computation component 110, and then cropping the shifted margin images. The convergence adjustment component 112 crops the shifted margin images to the size of the image before it was resized by the resize component 106. For example, if the size of the image before the margins were added was 720×1020, the shifted margin image is cropped to 720×1020. The convergence adjustment component 112 outputs the resulting stereoscopic images for further processing. The further processing may include, for example, displaying the stereoscopic images on the stereoscopic display 114, and encoding the stereoscopic images for storage and/or transmission.

The stereoscopic display 114 is a display configured to present stereoscopic images to a user of the stereoscopic imaging system 100 in a manner that allows stereoscopic vision. The stereoscopic display 114 may be any suitable display device capable of displaying stereoscopic content. For example, the stereoscopic display 114 may be a 2D or 3D display device, e.g., a 2D or 3D liquid crystal display (LCD) device, for which the stereoscopic images are converted anaglyph images that require special glasses to view the 3D effect. In another example, the stereoscopic display 114 may be a display with optical components that enable viewing of the 3D effect without special glasses, such as, for example, a stereoscopic 3D LCD device or a stereoscopic 3D organic electroluminescent display device.

In some embodiments, the stereoscopic imaging system 100 may be configured to operate as follows to capture stereoscopic images of a scene, and to automatically converge those stereoscopic images containing one or more faces. More specifically, a left image and a right image of a stereoscopic image of a scene are captured and processed by the stereoscopic imaging component 102 and the image processing component 104. The left and right images are then resized as needed by the resize component 106. That is, the resize component 106 generates detection images for the face detection component 108 and margin images for the convergence adjustment component 112.

The face detection component 108 then performs face detection on the left and right detection images, and provides information to the convergence computation component 110 regarding the size, the location, and a confidence metric for each detected face in the left and right images. The convergence computation component 110 then uses the information regarding any detected faces to select a suitable face for convergence. More specifically, the convergence computation component 110 uses the information regarding the detected faces and the disparity limit(s) of the stereoscopic imaging system to select a suitable face, if any. If a suitable face is found, the convergence computation component 110 determines a shift amount and direction for the left margin image and a shift amount and direction for the right margin image based on the horizontal disparity of the selected face. The convergence adjustment component 112 then shifts the left margin image horizontally in the specified direction by the left image shift amount and the right margin image horizontally in the specified direction by the right image shift amount, and crops the shifted images.

The automatic convergence may be performed, for example, on preview stereoscopic images during view finding, on stereoscopic images that are being recorded, and on previously recorded stereoscopic images. In some embodiments, the components of the stereoscopic imaging system 100 are embodied in a single digital system. The single digital system may be, for example, a cellular telephone, a smart cellular telephone, a laptop computer, a netbook computer, a tablet computing device, or a handheld gaming device. In some embodiments, different components may be embodied in separate digital systems. For example, the stereoscopic imaging component and the image processing component may be embodied in a digital camera and the other components may be embodied in a digital system that receives processed stereoscopic images from the camera.

Components of the stereoscopic imaging system 100 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, any software instructions may be stored in memory (not specifically shown) in the stereoscopic imaging system 100 and executed by one or more processors. The software instructions may be initially stored in a computer-readable medium such as a compact disc (CD), a diskette, a tape, a file, memory, or any other computer readable storage device and loaded and stored on the stereoscopic imaging system 100. In some cases, the software instructions may also be sold in a computer program product, which includes the computer-readable medium and packaging materials for the computer-readable medium. In some cases, the software instructions may be distributed to the stereoscopic imaging system 100 via removable computer readable media (e.g., floppy disk, optical disk, flash memory, USB key), via a transmission path from computer readable media on another computer system (e.g., a server), etc.

FIG. 2 shows a flow diagram of a method for automatic convergence of a stereoscopic image based on face detection in accordance with one or more embodiments. In general, the method detects one or more faces in a stereoscopic image, selects a suitable face for convergence, if any, from the detected face(s), and shifts the left and right images in the stereoscopic image such that the selected face is converged, i.e., horizontal disparity between the selected face in the left image and the selected face in the right image is reduced zero in the resulting stereoscopic image. The method may be performed, for example, during view finding when preview images are captured and displayed, during recording of stereoscopic images, and during review of previously recorded stereoscopic images. As is explained in more detail below, a detected face may not be suitable for convergence if the horizontal disparity of any of the other detected faces in the same stereoscopic image will exceed a positive disparity limit or a negative disparity limit after the left and right images are shifted to converge on the detected face. Note that a given face will have either positive horizontal disparity or negative horizontal disparity. The values of the disparity limits may be predetermined and/or may be set by user input.

As shown in FIG. 2, initially a stereoscopic image is received 200. Face detection is then performed on the stereoscopic image to locate any faces in the stereoscopic image 202. The face detection technique used may be any suitable 3D face detection technique. The face detection provides the location, the size, and a confidence metric for each detected face in the left image and the right image of the stereoscopic image. For simplicity of explanation, the location of a detected face is assumed to be as the x and y coordinates of the center of the face, the size of the face is assumed to be the length of a side of a square bounding box for the face, and the confidence metric is assumed to be an integer value indicating how confident the face detection is that what it detected is actually a face. One of ordinary skill in the art will understand other method embodiments in which the face detection provides different indications of face location, face size, and/or confidence.

If no faces are detected 204, the process continues with another stereoscopic image, if any 218. If one or more faces are detected in the stereoscopic image 204, the detected face(s) are analyzed based on various criteria to select one suitable for convergence 205-212. To facilitate understanding, the selection process is described using an example stereoscopic image with five faces. Further, the positive disparity limit is assumed to be 32 and the negative disparity limit is assumed to be −19.

Referring again to FIG. 2, ordered convergence analysis tables containing information about each of the detected faces in the left image and the right image of the stereoscopic image are created 205. That is, two ordered convergence analysis tables are created, one for the left image and one for the right image. A convergence analysis table for an image includes an entry for each detected face that records the x and y coordinates of the center of the face in that image, the size of the face, the confidence metric for the face, and the Euclidean distance from the center of the face in the image to the center of the image.

The table is ordered according to the sizes, distances, and confidence metrics of the faces. More specifically, the first level ordering in the table is according to size, from largest to smallest. The second level ordering in the table is according to distance. That is, if two or more faces are the same size, the entries for those faces are ordered according to their distances, from smallest to largest. The third level ordering in the table is according to the confidence metrics. That is, if two or more faces are the same size and have the same distance, the entries for those faces are ordered according to the confidence metrics, from highest to lowest. If all three criterion are the same for two or more faces, the entries for those faces are ordered according to their indices, from smallest to largest.

Tables 1A and 1B show respective convergence analysis tables for the left image and the right image of the example stereoscopic image before ordering, and Tables 2A and 2B show the respective convergence analysis tables after ordering. The index i identifies each distinct face. Note that face 1 and face 5 are the same size, 40, and face 2 and face 3 are the same size, 50, thus requiring a second level ordering according to the distances of those faces.

TABLE 1A

| | | | Euclidean Distance | | |
|---|---|---|---|---|---|
| | | | to center | | |
| i | CenterX_i | CenterY_i | (D_i) | Size_i | Conf_i |
| 1 | 25 | 25 | 165.1 | 40 | 0 |
| 2 | 34 | 52 | 143.2 | 50 | 3 |
| 3 | 128 | 90 | 43.9 | 50 | 0 |
| 4 | 124 | 140 | 41.2 | 60 | 6 |
| 5 | 18 | 200 | 163.0 | 40 | 4 |

TABLE 1B

| | | | | Euclidean Distance | |
|---|---|---|---|---|---|
| | | | | to center | |
| i | CenterX_i | CenterY_i | Size_i | (D_i) | Conf_i |
| 1 | 24 | 25 | 40 | 165.9 | 0 |
| 2 | 30 | 51 | 50 | 147.2 | 3 |
| 3 | 108 | 94 | 50 | 58.1 | 1 |
| 4 | 129 | 140 | 60 | 36.9 | 6 |
| 5 | 20 | 193 | 40 | 157.9 | 4 |

TABLE 2A

| | | | Euclidean Distance | | |
|---|---|---|---|---|---|
| | | | to center of | | |
| i | CenterX_i | CenterY_i | image (D_i) | Size_i | Conf_i |
| 4 | 124 | 140 | 41.2 | 60 | 6 |
| 3 | 128 | 90 | 43.9 | 50 | 0 |
| 2 | 34 | 52 | 143.2 | 50 | 3 |
| 5 | 18 | 200 | 163.0 | 40 | 4 |
| 1 | 25 | 25 | 165.1 | 40 | 0 |

TABLE 2B

| | | | | Euclidean Distance | |
|---|---|---|---|---|---|
| | | | | to center of | |
| i | CenterX_i | CenterY_i | Size_i | image (D_i) | Conf_i |
| 4 | 129 | 140 | 60 | 36.9 | 6 |
| 3 | 108 | 94 | 50 | 58.1 | 1 |
| 2 | 30 | 51 | 50 | 147.2 | 3 |
| 5 | 20 | 193 | 40 | 157.9 | 4 |
| 1 | 24 | 25 | 40 | 165.9 | 0 |

Referring again to FIG. 2, the horizontal disparities of the detected faces are computed 206. In the example stereoscopic image, the horizontal disparity for face 1 is 24−25=−1, the horizontal disparity for face 2 is 30−34=−4, the horizontal disparity for face 3 is 108−128=−20, the horizontal disparity for face 4 is 129−124=5, and the horizontal disparity for face 5 is 20−18=2.

Each face entry in the ordered convergence analysis tables is then considered in entry order, beginning with the first entry, until a suitable face for convergence is found or all the faces have been tested 208-214. The first face entry is selected 208, and a shift amount and direction for the left image and a shift amount and direction for the right image is determined based on the horizontal disparity for that face entry. These shift amounts and directions may be determined as previously described. The left and right shift amounts are then used to determine whether or not the horizontal disparities of the other detected faces will be acceptable if the left and right images are shifted by these amounts 212. The horizontal disparity of a face if the left and right images are shifted by the left and right shift amounts may be computed as (X_{R}+RSA)−(X_{L}−LSA) if the left image is to be shifted left and the right image is to be shifted right or (X_{R}−RSA)−(X_{L}+LSA) if the left image is to be shifted right and the right image is to be shifted left, where X_{R} is the X coordinate of the center of the face in the right image, X_{L} is the X coordinate of the center of the face in the left image, RSA is the right shift amount, and LSA is the left shift amount.

If the horizontal disparity of any of the faces will not be acceptable 212, the face corresponding to the face entry being considered is not a suitable face for convergence and the next face entry in the tables, if any 214, is tried. If all face entries have been tried 214, the processing continues with another stereoscopic image, if any 218.

If the horizontal disparity of all the faces will be acceptable 212, the face corresponding to the face entry under consideration is a suitable face for convergence. The left image is then horizontally shifted in the left shift direction by the left shift amount and the right image is horizontally shifted in the right shift direction by the right shift amount to generate the final stereoscopic image 218. The left and right shift amounts may be appropriately translated prior to shifting if the images used for face detection and convergence computation are of a different resolution that the images that will be shifted. Processing then continues with another stereoscopic image, if any 218.

Referring to Tables 2A and 2B, in the example stereoscopic image, the first entry in the convergence analysis tables to be considered corresponds to face 4. The horizontal disparity for this face is 129−124=5. Based on this horizontal disparity, the left shift amount will be 3 and the right shift amount will be 2. However, the horizontal disparity of one of the other faces, face 3, after the images are shifted by these values will not be acceptable. The horizontal disparity for face 3 if the images are shifted is (108−2)−(128+3)=−25. Note that this horizontal disparity exceeds the negative disparity limit, i.e., −25<−19. Thus, face 4 is not a suitable face for convergence.

The next entry in the convergence analysis table to be considered corresponds to face 3. The horizontal disparity for this face is 108−128=−20. Based on this horizontal disparity, the left shift amount is set to 10 and the right shift amount is set to 10. Because the center horizontal disparity is negative, the shift direction for the left image is left and the shift direction for the right image is right. The horizontal disparities of the other four faces after shifting by these amounts will also be acceptable. Thus, face 3 is a suitable face for convergence.

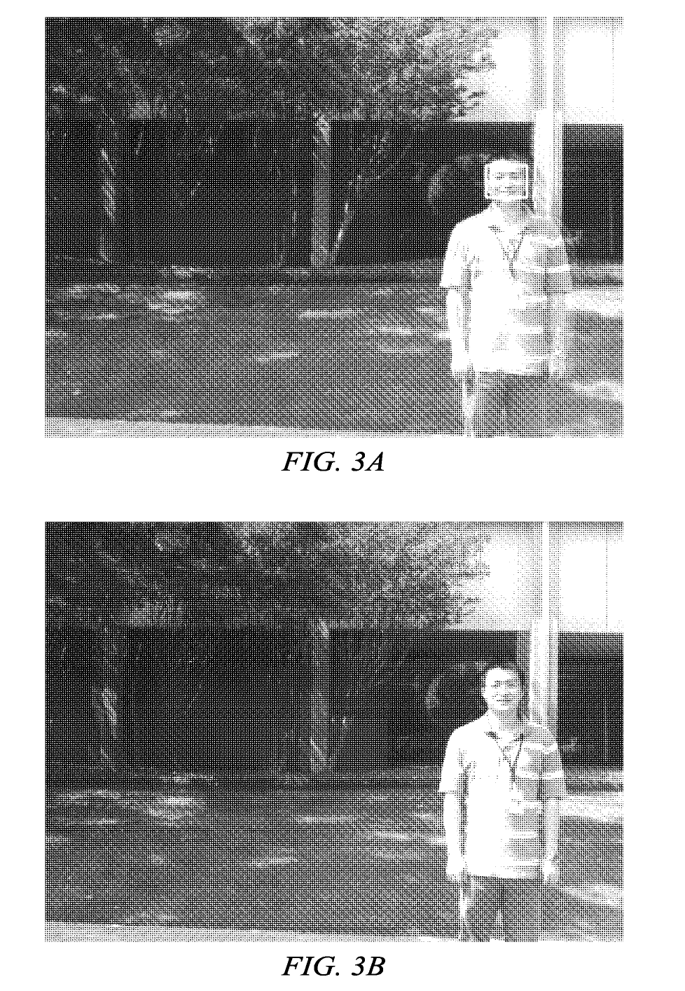

FIGS. 3A and 3B show a simple example of application of an embodiment of the automatic convergence method to a still stereoscopic image, i.e., a stereoscopic photograph. FIG. 3A shows the stereoscopic image before convergence with a box around the face of the individual in the scene. FIG. 3B shows the converged stereoscopic image after the automatic convergence method is applied and the face is converged.

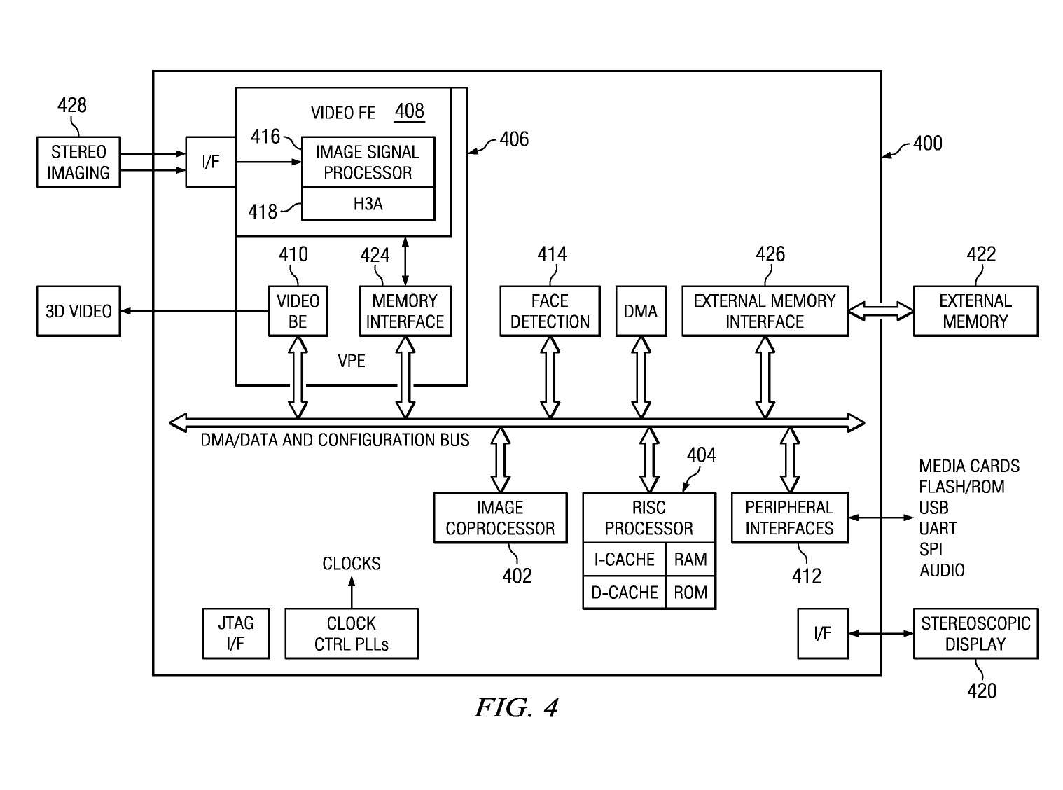

FIG. 4 shows an illustrative digital system 400 suitable for use as an embedded system, e.g., in a digital camera or a cellular telephone, in accordance with one or more embodiments. The digital system 400 includes, among other components, an image coprocessor (ICP) 402, a RISC processor 404, a video processing engine (VPE) 406, and a face detection engine 414 that may be configured to perform automatic convergence of stereoscopic images as described herein. The digital system 400 also includes an interface for a stereoscopic display 420, an external memory interface 426, and peripheral interfaces 412 for various peripherals that may include a multi-media card, an audio serial port, a Universal Serial Bus (USB) controller, a serial port interface, etc.

The RISC processor 404 may be any suitably configured RISC processor. The ICP 402 may be, for example, a digital signal processor (DSP) or other processor designed to accelerate image processing. The face detection engine 414 includes functionality to perform face detection on stereoscopic images.

The VPE 406 includes a configurable video processing front-end (Video FE) 408 input interface used for stereoscopic image capture from a stereoscopic imaging peripheral 408, a configurable video processing back-end (Video BE) 410 output interface used for stereoscopic display devices, and a memory interface 424 shared by the Video FE 408 and the Video BE 410.

The Video FE 408 includes functionality to perform image enhancement techniques on raw stereoscopic image data from a stereoscopic imaging peripheral 428. The image enhancement techniques may include, for example, black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment. The Video FE 408 includes an image signal processor (ISP) 416, and an H3A statistic generator 3A) 418. The ISP 416 is customizable for various imaging sensor types, e.g., CCD or CMOS, and supports video frame rates for preview displays of captured stereoscopic images and for video and still image recording modes. The ISP 416 also includes, among other functionality, an image resizer, statistics collection functionality, and a boundary signal calculator. The H3A module 418 includes functionality to support control loops for auto focus, auto white balance, and auto exposure by collecting metrics on the raw image data from the ISP 416 or external memory 422.

The Video BE 410 includes functionality to manage display data in various formats for several different types of stereoscopic display devices, and to format display data into the output format and output signals required to interface to various stereoscopic display devices.

The memory interface 424 functions as the primary source and sink to modules in the Video FE 408 and the Video BE 410 that are requesting and/or transferring data to/from external memory 422. The memory interface 424 includes read and write buffers and arbitration logic.

The digital system 400 may be configured to operate as follows. The Video FE 408 receives stereoscopic image data for a stereoscopic image from the stereoscopic imaging peripheral 428, applies enhancement techniques to the left and right images, resizes the left and right images to generate detection images and margin images, and stores the detection images and margin images in external memory 422. The face detection engine 414 retrieves the left and right detection images from the external memory 422, performs face detection on the images, and stores information regarding any detected faces in the external memory 422. The ICP 402 retrieves the information regarding the detected face(s) and the left and right margin images from the external memory 422. Software executing on the ICP 402 analyzes the information regarding the detected faces to determine if a face suitable for convergence is present. If a suitable face is found, the software determines shift amounts and shift directions for horizontally shifting the left and right margin images to converge on the face. The ICP 402 then shifts the left margin image and the right margin image according the respective shift amounts and shift directions, crops the shifted images, and stores the final stereoscopic image in the external memory 422. If a suitable face is not found, the ICP 402 crops the margin images and stores the final stereoscopic image in the external memory 422. Camera control software executing on the RISC processor 404 retrieves the final stereoscopic image from the external memory 422, and displays the stereoscopic image on the stereoscopic display 420.

Embodiments of the automatic convergence method described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

The steps in the flow diagram herein are described in a specific sequence merely for illustration. Alternative embodiments using a different sequence of steps may also be implemented without departing from the scope of the present disclosure, as will be apparent to one skilled in the relevant arts by reading the disclosure provided herein.

While the invention has been described with respect to a limited number of embodiments, those skilled in the art, having benefit of this disclosure, will appreciate that other embodiments can be devised which do not depart from the scope of the invention as disclosed herein.

What is claimed is:

1. A method for automatic convergence of stereoscopic images, the method comprising:
receiving a stereoscopic image;
selecting a face detected in the stereoscopic image; and
shifting at least one of a left image in the stereoscopic image and a right image in the stereoscopic image horizontally, wherein horizontal disparity between the selected face in the left image and the selected face in the right image before the shifting is reduced.

2. The method of claim 1, wherein the horizontal disparity is reduced to zero.

3. The method of claim 1, further comprising:
computing the horizontal disparity between the selected face in the left image and the selected face in the right image;
computing a first shift amount and a first shift direction based on the horizontal disparity; and wherein
shifting at least one of a left image further comprises shifting one of the left image and the right image horizontally in the first shift direction by the first shift amount.

4. The method of claim 3, wherein computing the horizontal disparity further comprises computing the horizontal disparity as a difference between an X coordinate of a pixel in the selected face in the left image and an X coordinate of a corresponding pixel in the right image.

5. The method of claim 3, further comprising:
computing a second shift amount and a second shift direction based on the horizontal disparity; and wherein
shifting at least one of a left image comprises shifting the left image horizontally in the first shift direction by the first shift amount and shifting the right image horizontally in the second shift direction by the second shift amount.

6. The method of claim 3, wherein selecting a face comprises:
detecting a plurality of faces comprising the face in the stereoscopic image; and
selecting the face from the plurality of faces based on a size of the face.

7. The method of claim 6, wherein selecting the face further comprises:
selecting the face based on a location of the face.

8. The method of claim 7, wherein selecting the face further comprises:
selecting the face based on a confidence metric for the face.

9. The method of claim 8, wherein selecting the face further comprises:
selecting the face when horizontal disparity of each remaining face in the plurality of faces will be within a horizontal disparity limit after the left image and the right image are shifted.

10. The method of claim 1, further comprising:
displaying the stereoscopic image on a stereoscopic display.

11. An apparatus comprising:
means for performing face detection on a stereoscopic image comprising a left image and a right image;
means for selecting a face detected by the face detection;
means for determining a first shift amount and a first shift direction for the left image and a second shift amount and a shift second direction for the right image based on horizontal disparity between the selected face in the left image and the selected face in the right image, wherein if the left image is shifted horizontally in the first shift direction by the first shift amount and the right image is shifted horizontally in the second shift direction by the second shift amount, the horizontal disparity is reduced to zero; and
means for shifting the left image according to the first shift amount and the first shift direction and the right image according to the second shift amount and the second shift direction.

12. The apparatus of claim 11, further comprising:
a stereo imaging component configured to capture the stereoscopic image.

13. The apparatus of claim 11, further comprising:
a stereoscopic display configured to display the stereoscopic image.

14. The apparatus of claim 11, wherein the means for selecting a face comprises:
means for selecting the face from a plurality of faces detected by the means for face detection, wherein the selecting is based on at least one of a size of the face, a location of the face, and a confidence metric.

15. The apparatus of claim 14, wherein the means for selecting the face further comprises:
means for selecting the face when horizontal disparity of each remaining face in the plurality of faces will be within a horizontal disparity limit after the left image and the right image are shifted.

16. A computer readable medium storing software instructions that when executed in a digital system cause the digital system to perform a method comprising:
selecting a face detected in a stereoscopic image;
computing a first shift amount and first shift direction based on horizontal disparity between the face in a left image of the stereoscopic image and the face in a right image of the stereoscopic image; and
shifting one of the left image and the right image in the stereoscopic image horizontally in the first shift direction by the first shift amount.

17. The computer readable medium of claim 16, wherein the method further comprises:
computing a second shift amount and a second shift direction based on the horizontal disparity; and wherein
shifting one of the left image comprises shifting the left image horizontally in the first shift direction by the first shift amount and shifting the right image horizontally in the second shift direction by the second shift amount.

18. The computer readable medium of claim 16, wherein selecting a face further comprises:
selecting the face from a plurality of faces detected in the stereoscopic image by the face detection component, the selecting based on at least one of a size of the face, a location of a face, and a confidence metric for the face.

19. The computer readable medium of claim 18, wherein selecting the face further comprises:
selecting the face when horizontal disparity of each remaining face in the plurality of faces will be within a horizontal disparity limit after the left image and the right image are shifted.

20. The computer readable medium of claim 16, further comprising:
displaying the stereoscopic image on a stereoscopic display.
